(19) United States
(12) Patent Application Publication
(10) Pub. No.: US 2016/0060281 A1
(43) Pub. Date: Mar. 3, 2016

(54) BUTADIEN2,3-DIYL LINKED DI-DOPO DERIVATIVES AS FLAME RETARDANTS

(71) Applicants: SCOTT Edward ANGELL, Pasadena, TX (US); Kimberly WHITE, (US); Lu Li ANGLELL, (US); Arthur MACK, Prairieville (US); ALBEMARLE CORPORATION, Baton Rouge, LA (US)

(72) Inventors: Scott Edward Angell, Pasadena, TX (US); Kimberly A. White, Baton Rouge, LA (US); Yu Li Angell, Pasadena, TX (US); Arthur G. Mack, Prairieville, LA (US)

(21) Appl. No.: 14/888,561

(22) PCT Filed: May 2, 2014
(86) PCT No.: PCT/US2014/036579

§ 371 Date: Nov. 2, 2015

Related U.S. Application Data
(60) Provisional application No. 61/829,326, filed on May 31, 2013.

(51) Int. Cl. C07F 9/6571; C08K 5/5313; C09K 21/12

(52) U.S. Cl. CPC C07F 9/657172; C09K 21/12; C08K 5/5313

(57) ABSTRACT

Disclosed are novel, halogen-free flame-retardants derived from 9,10-Dihydro-9-Oxa-10-Phosphaphenantrene-10-oxide (DOPO) of the structure below: This invention also relates to the use of the halogen free DOPO derived compositions as flame-retardants in polymers, and a process of preparing the above compounds by reacting a formula A compound with a formula B compound:

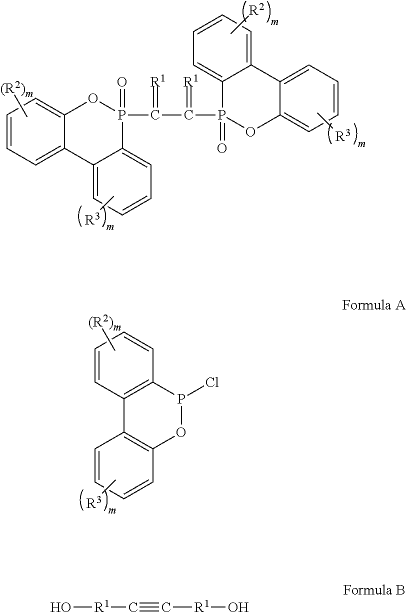

### FIELD OF THE INVENTION

The present invention relates to novel, halogen-free flame-retardants derived from 9,10-Dihydro-9-Oxa-10-Phosphaphenantrene-10-oxide (DOPO). This invention also relates to the use of the halogen free DOPO derived flame-retardants in polymers.

### BACKGROUND OF INVENTION

Polymers as a class of materials are generally flammable. Owing to their combustibility, thermoplastic and thermoset polymers, for example polyamides, polyesters, epoxy resins and polyurethanes, require the use of flame-retardants for many applications. Typically, halogenated compounds, more specifically, aromatic polybrominated compounds, have been used as flame-retardant additives in polymers. It is generally accepted that these products inhibit radical gas phase reactions from occurring in the flame when these products are ignited. This makes halogenated flame-retardants very commonly used additives for different types of polymeric materials. However, during the last fifteen years or so, halogenated flame-retardants have come under scrutiny because of ecological concerns. At this time, the flame-retardant industry is under pressure to change to flame-retardants that are perceived to be more environmentally friendly, such as organophosphorus flame-retardants.

A wide variety of organophosphorus compounds have been shown in the prior art to impart flame retardancy to polymers. Most of the phosphorus-containing flame-retardants provide flame-retardant activity through a combination of vapor and condensed phase reactions, polymer carbonization promotion, and char formation. However, there are usually problems associated with the use of organophosphorus flame-retardant materials. One source of difficulty relates to the processing of polymers, which often requires high temperatures, potentially at temperatures above 210° C. and often as high as 310-350° C. Unfortunately, flame-retardants often participate in decomposition or side reactions, which impart undesirable properties to the base polymer or polymer system. Other flame-retardants become too volatile under processing conditions and are not effectively retained during processing.

It is desirable therefore, to develop new flame-retardants, which are thermally and hydrolytically stable and able to withstand high temperature polymer processing.

### SUMMARY OF THE INVENTION

The present invention relates to a compound, useful for a flame-retardant, having the following structure:

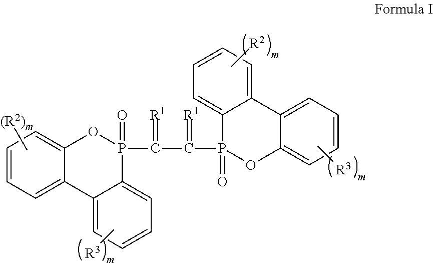

wherein R¹ is C(R⁴)₂; each R² and R³ are independently hydrogen, C₁-C₁₅ alkyl, C₆-C₁₂ aryl, C₇-C₁₅ aralkyl or C₇-C₁₅ alkaryl; or R² and R³ taken together can form a saturated or unsaturated cyclic ring, wherein said saturated or unsaturated cyclic ring may be optionally substituted by a C₁-C₆ alkyl; each R⁴ is independently hydrogen, C₁-C₆ alkyl, C₆-C₁₂ aryl or C₃-C₁₂ cycloalkyl; and each m is independently 1, 2, 3 or 4.

### DETAILED DESCRIPTION OF THE INVENTION

The present invention relates to a compound, useful for a flame-retardant additive, having the following structure:

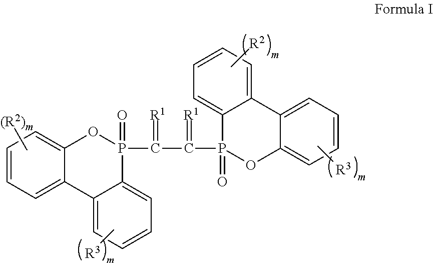

wherein R¹ is C(R⁴)₂; each R² and R³ are independently hydrogen, C₁-C₁₅ alkyl, C₆-C₁₂ aryl, C₇-C₁₅ aralkyl or C₇-C₁₅ alkaryl; or R² and R³ taken together can form a saturated or unsaturated cyclic ring, wherein said saturated or unsaturated cyclic ring may be optionally substituted by a C₁-C₆ alkyl; each R⁴ is independently hydrogen, C₁-C₆ alkyl, C₆-C₁₂ aryl or C₃-C₁₂ cycloalkyl; and each m is independently 1, 2, 3 or 4.

In another aspect, R² and R³ are independently hydrogen or a C₁-C₆ alkyl. In another aspect, all R⁴ substituents are hydrogen. In yet another aspect, R² and R³ are hydrogen.

The term “alkyl”, as used herein, unless otherwise indicated, includes saturated monovalent hydrocarbon radicals having straight or branched moieties. Examples of alkyl groups include, but are not limited to, methyl, ethyl, propyl, isopropyl, butyl, isobutyl, t-butyl, pentyl and hexyl.

The term “aryl”, as used herein, unless otherwise indicated, includes an organic radical derived from an aromatic hydrocarbon by removal of one hydrogen, such as phenyl, naphthyl, indenyl, and fluorenyl. “Aryl” encompasses fused ring groups wherein at least one ring is aromatic.

The term “aralkyl” as used herein indicates an “aryl-alkyl-” group. Non-limiting example of an aralkyl group is benzyl(C₆H₅CH₂—) and methylbenzyl(CH₃C₆H₄CH₂—).

The term “alkaryl” as used herein indicates an “alkyl-aryl-” group. Non-limiting examples of alkaryl are methylphenyl-, dimethylphenyl-, ethylphenyl-propylphenyl-, isopropylphenyl-, butylphenyl-, isobutylphenyl- and t-butylphenyl-.

The term “cycloalkyl”, as used herein, includes non-aromatic saturated cyclic alkyl moieties wherein alkyl is as defined above. Examples of cycloalkyl include, but are not limited to, cyclopropyl, cyclobutyl, cyclopentyl, cyclohexyl, and cycloheptyl.

Unless otherwise indicated, all the foregoing groups derived from hydrocarbons may have up to about 1 to about 20 carbon atoms (e.g., C₁-C₂₀ alkyl, C₆-C₂₀ aryl, C₇-C₂₀ alkaryl, C₇-C₂₀ aralkyl) or 1 to about 12 carbon atoms (e.g., C₁-C₁₂ alkyl, C₆-C₁₂ aryl, C₇-C₁₂ alkaryl, C₇-C₁₂ aralkyl), or 1 to about 8 carbon atoms, or 1 to about 6 carbon atoms.

### Use of the Compounds of the Invention

This invention also related to a flame-retardant polymer composition comprising a polymer and the flame-retardant amount of the compounds of Formula I. Polymer that may be used in the flame-retardant polymer composition include, but are not limited to: polyolefins, polyesters, polyethers, polyketones, polyamides, polyvinylchlorides, natural and synthetic rubbers, polyurethanes, polystyrenes, poly(meth)acrylates, phenolic resins, polybenzoxazine, polyacetals, polyacrylonitriles, polybutadienes, polystyrenes, polyimides, polyamideimides, polyetherimides, polyphenylsulfides, polyphenylene oxide, polycarbonates, cellulose, cellulose derivatives, cyanate esters, polyphenylene esters, polybutadiene resins, butadiene-styrene resins, butadiene-divinylbenzene-styrene resins, epoxy-modified polybutadiene resins, acrylic or vinyl acetate adhesives, carboxyl-terminated butadiene-acrylonitrile copolymers, phenylene ethers, maleic anhydride-grafted butadiene-styrene copolymers, maleic anhydride-modified 4-methyl-1pentene resins, maleated 1-butene-ethylene copolymers, resins derived from vinylbenzyl ether compounds, epoxy resins or mixtures thereof. Preferably, the polymers are polyesters, phenolic resins, phenol triazine novolaks, cresol triazine novolaks, triazine phenol epoxy novolaks, triazine cresol epoxy novolaks, polyamides, polyurethanes, polystyrene, epoxy resins or mixtures thereof.

Another embodiment is when the flame-retardant composition further comprises at least one conventional additive, such as heat stabilizers, light stabilizers, ultra-violet light absorbers, anti-oxidants, anti-static agents, preservatives, adhesion promoters, fillers, pigments, dyes, lubricants, mold releasers, blowing agents, fungicides, plasticizers, processing aids, acid scavengers, dyes, pigments, nucleating agents, wetting agents, dispersing agents, synergists, mineral fillers, reinforcing agents such as glass fiber, glass flake, carbon fiber, or metal fiber; whiskers such as potassium titanate, aluminum borate, or calcium silicate; inorganic fillers and other fire-retardant additives, smoke suppressants and mixtures thereof.

The other flame-retardant additives which may be used with the compounds of formulas Formula I include, but are not limited to, nitrogen-containing synergists such as ammonium polyphosphate, melamine, melamine phosphate, melamine cyanurate, melamine pyrophosphate, melamine polyphosphate, Melam (1,3,5-triazine-2,4,6-triamine-n-(4,6-diamino-1,3,5-triazine-2-yl), Melem(-2,5,8-triamino-1,3,4,6,7,9,9b-Heptaazaphenalene), Melon (poly[8-amino-1,3,4,6,7,9,9b-Heptaazaphenalene-2,5-diyl)imino]phosphate and cyanurate derivatives of guanidine and piperazine, phosphazene compound, polyphophazenes, antimony oxide, silica, talc, hydrotalcite, borate salts, hydrated alumina such as aluminum hydroxide (ATH), boehmite, bismuth oxide, molybdenum oxide, or mixtures of these compounds with zinc, aluminum and/or magnesium oxide or salts.

The amount of compound of Formula I added to the polymer as a flame-retardant may be varied over a wide range. Usually from about 0.1 to about 150 parts by weight of the compounds of Formula I are used per 100 parts by weight of polymer. Preferably about 0.5 to about 100 parts of the compounds of Formula I are used per 100 parts by weight of polymer, or from about 2 to about 70 parts by weight per 100 parts by weight of polymer or from about 2 to about 50 parts by weight per 100 parts by weight of polymer.

Masterbatches of polymer containing the compounds of Formula I of this invention, which are blended with additional amounts of substrate polymer, can contain even higher concentrations of the compounds of Formula I, e.g., from about 100 to about 1000, or from about 100 to about 500, or from about 100 to about 250 parts by weight of the compounds of Formula I per 100 parts by weight of polymer.

Alternatively, the amount of the phosphorus compounds of Formula I in the flame-retardant polymer composition is selected so the composition will contain about 0.5 wt % to about 10 wt % or about 1.2 wt % to about 7 wt %, or about 1.5 wt % to about 5 wt % phosphorous content, based on the total weight of the composition.

Particular polymers that may be used in combination with the compounds of Formula I are:
A. Polyphenylene oxides and sulfides, and blends of these polymers with polystyrene graft polymers or styrene copolymers such as high impact polystyrene, EPDM copolymers with rubbers, as well as blends of polyphenylene oxide with polyamides and polyesters.
B. Polyurethanes which are derived from polyethers, polyesters or polybutadiene with terminal hydroxyl groups on the one hand and aliphatic or aromatic polyisocyanates on the other hand including polyisocyanurates, as well as precursors thereof.
C. Polyamides including copolyamides which are derived from diamines and dicarboxylic acids and/or from aminocarboxylic acids or the corresponding lactams, such as polyamide 4, polyamide 6, polyamide 6/6, polyamide 6/10, polyamide 11, polyamide 12, poly-2,4,4-trimethylhexamethylene terephthalamide or poly-m-phenylene iso-phthalamide, as well as copolymers thereof with polyethers, such as with polyethylene glycol, polypropylene glycol or polytetramethylene glycols.
D. Polyesters which are derived from dicarboxylic acids and di-alcohols and/or from hydroxycarboxylic acids or the corresponding lactones, such as polyethylene terephthalate, polybutylene terephthalate, poly-1,4-dimethylol-cyclohexane terephthalate and polyhydroxybenzoates as well as block-copolyether-esters derived from polyethers having hydroxyl end groups.
E. Polystyrene and graft copolymers of styrene, for example styrene on polybutadiene, styrene and acrylonitrile on polybutadiene, styrene and alkyl acrylates or methacrylates on polybutadiene, styrene and acrylonitrile on ethylene/propylene/diene terpolymers, styrene and acrylonitrile on polyacrylates or polymethacrylates, styrene and acrylonitrile on acrylate/butadiene copolymers, as well as mixtures thereof with random copolymers of styrene or α-methylstyrene with dienes or acrylic derivatives, for instance the terpolymers of styrene known as ABS, MBS, ASA or AES terpolymers.
F. Epoxy resins are compounds that are prepared by polyaddition reaction of an epoxy resin component and a crosslinking (hardener) component. The epoxy resin components used are aromatic polyglycidyl ethers such as bisphenol A diglycidyl ether, bisphenol F diglycidyl ether, polyglycidyl ethers of phenol-formaldehyde resins and of cresol-formaldehyde resins, polyglycidyl ethers of phthalic, isophthalic and terephthalic acid, and also of trimellitic acid, N-glycidyl compounds of aromatic amines and of heterocyclic nitrogen bases, and also di- and polyglycidyl compounds of polyhydric aliphatic alcohols. The hardeners used are polyamines such as dicyandiamide (DICY), phenolic novolacs, cresol novolacs, triethylenetetramine, aminoethylpiperazine and isophoronediamine, polyamidoamines, polybasic acids or anhydrides thereof, for example phthalic anhyride, hexahydrophthalic anhydride, methyltetrahydrophthalic anhydride or phenols. The cross-linking may also be affected by polymerization using suitable catalysts or promoters, such as 2-phenylimidazole, 2-methylimidazole, benzyl dimethylamine (BDMA), etc.

### G. Polycarbonates.

Polyesters, phenolic resins, polyamides, polyurethanes, polystyrene and epoxy resins are particularly suitable.

The flame-retardant additive of Formula I may be incorporated into the polymer by a variety of mixing techniques, such as solution blending and melt blending. Examples of melt blending equipment include twin screw extruders, single screw extruders, Banbury mixers, roll mixers, kneaders, etc. The melt blending temperature depends on the resin being used and is within the range from about 150° C. to about 400° C. When using an extruder for melt blending, in some instances, the extrudate exits through small die holes, and the strands of molten composition are cooled by passing through a water bath. The cooled strands can be pelletized. The pellets can be used to prepare molded articles. In some instances, it is necessary to dry the composition prior to molding. A further technique is to add the flame-retardant to finished polymer granules or powders and to process the mixture directly to provide a plastic article.

The method used in producing a plastic article from the flame-retardant resin composition of the present invention is not particularly limited, and any method commonly used may be employed. Exemplary such methods include moldings such as injection molding, blow molding, extrusion, sheet forming, thermal molding, rotational molding, and lamination.

### Thermoset Applications

Because of their excellent flame retardant characteristics and ability to produce polymer compositions with good thermal, mechanical, physical and electric properties, the phosphorus flame retardants of Formula I may be used in thermoset applications such as laminates for printed circuit boards (PCB) and composites for aerospace. A number of different formulations and components may be used to produce these laminates and composites including the resins systems discussed below.

### Cyanate Ester Resins

Cyanate ester resins are derived from cyanate ester monomers and will form a triazine structure upon curing. They may be used alone or with other materials such as epoxies monomers or resin, bismaleimides (discussed below) to form BT resins, and other resins used in the PCB and composite areas.

A non-limiting exemplary structure of a cyanate ester is a composition shown below in Formula II:

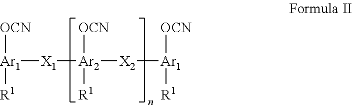

wherein each Ar1 and Ar2 are independently phenylene, biphenylene, naphthylene and anthrylene; each X1 and X2 are independently C₁-C₈ alkylene, C₁-C₈ haloalkylene, C3-C₁₆ cycloalkylene, —S—, carbonyl, or carboxyl; and each R1 is independently hydrogen or a C₁-C₈ alkyl and n is a whole number from 0 to 10.

Cyanate esters and resins are commercial materials. Non-limiting examples of cyanate esters are dicyanatobenzenes, tricyanatobenzenes, dicyanatonaphthalenes, tricyanatonaphthalenes, dicyanato-biphenyl, bis(cyanatophenyl)methanes and alkyl derivatives thereof, bis(dihalocyanatophenyl)propanes, bis(cyanatophenyl)ethers, bis(cyanatophenyl)sulfides, bis(cyanatophenyl)propanes, phosphorus-containing cyanate esters (e.g., tris(cyanatophenyl)phosphites, tris(cyanatophenyl)phosphates, and the like), bis(halocyanatophenyl)methanes, cyanated novolac, bislcyanatophenyl(methylethylidene)]benzene, cyanated bisphenol-terminated thermoplastic oligomers, 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane and 3,3′,5,5′-tetramethyl bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis (4-cyanatophenyl)propane; tris(4-cyanatophenyl)-phosphite; tris(4-cyanatophenyl)phosphate; bis(3-chloro-4-cyanatophenyl)methane; cyanated novolac; 1,3-bis[4-cyanatophenyl-1-(methylethylidene)]benzene, cyanated bisphenol-terminated polycarbonate or other thermoplastic oligomer, and the like, as well as combinations of any two or more thereof.

Preferred cyanate ester monomers from which the triazines are prepared include bisphenol-A cyanate esters, bisphenol-E cyanate esters, tetramethylbisphenol-F cyanate esters, bisphenol-M cyanate esters, phenol Novolac cyanate esters, bisphenol-C cyanate esters, dicyclopentadienyl-bisphenol cyanate esters, Novolac cyanate esters, and the like, as well as mixtures of any two or more thereof.

### Polybenzoxazines

Polybenzoxazines are made from benzoxazine monomer, which upon heating or curing, causes the heterocyclic oxazine ring to open forming the polymer where the nitrogen is in the main chain of the polymer.

A non-limiting exemplary structure of a benzoxazine monomer is a composition shown below in Formula III:

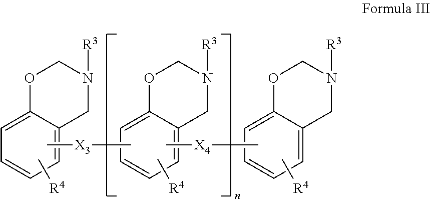

where wherein each X3 and X4 are independently C₁-C₈ alkylene, C₁-C₈ haloalkylene, C₃-C₁₆ cycloalkylene, —S—, carbonyl, or carboxyl; and each R⁴ is independently a C₁-C₃ alkyl or a phenyl and n is a whole number from 0 to 10.

### Bismaleimides

Another component that may be added in the laminate or composite formulation is bismaleimides. They are typically used in conjunction with the cyanate monomers to form the so called BT (bismaleimide-triazine) resins.

A non-limiting exemplary structure of a bismaleimides is shown below in Formula IV:

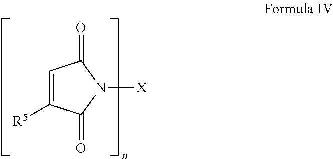

wherein X is alkylene, cycloalkylene, arylene, polyarylene, heteroarylene, polyheteroarylene or bisarylene; wherein bisarylene is Ar—Y—Ar—, and Ar is arylene, Y is a direct bond, —O—, —S— or C₁ to C₆ alkylene; R⁵ is hydrogen or a C₁ to C₆ alkyl, and n is 2 to 10.

Exemplary bismaleimides contemplated for use in the practice of the present invention are selected from the group consisting of N,N′-m-phenylene bismaleimide, N,N′-p-phenylene bismaleimide, N,N′-m-toluene bismaleimide, N,N′-4,4′-biphenylene bismaleimide, N,N′-4,4′-[3,3′-dimethyl-biphenylene]bismaleimide, N,N′-4,4′-[3,3′-dimethyldiphenylmethane]bis maleimide, N,N′-4,4′43,3′-diethyldiphenylmethane]bismaleimide, N,N′-4,4′-diphenylmethane bismaleimide, N,N′-4,4′-diphenylpropane bismaleimide, N,N′-4,4′-diphenylether bismaleimide, N,N′-3,3′-diphenylsulfone bismaleimide, N,N′-4,4′-diphenylsulfone bismaleimide, 2,2-bis[4-(4-maleimidephenoxy)phenyl]nonane, 2,2-bis[3-tertiary butyl-4-(-maleimidephenoxylphenyl]propane, 2,2-bis[3-secondary butyl-4-(4-maleimidephenoxy)phenyl]propane, 1,1-bis[4-(4-maleimidephenoxy)phenyl]decane, 1,1-bis [2-methyl-4-(4-maleimidephenoxy)-5-tertiary butyl phenyl]-2-methylpropane, 4,4′-cyclohexylidene-bis[1-(4-maleimidephenoxy)-2-(1,1-dimethylethyl)benz-ene], 4,4′-methylene-bis[1-(4-maleimidephenoxy)-2,6-bis(1,1′-dimethylethyl-)benzene], 4,4′-methylene-bis[1-(4-maleimidephenoxy)-2,6-di-secondary butyl benzene], 4,4′-cyclohexylidene-bis[1-(4-maleimidephenoxy)-2-cyclohexylbenzene], 4,4′-methylene-bis[1-(maleimidephenoxy)-2-nonylbenzene], 4,4′-(1-methylethylidene)-bis[1-(maleimidephenoxy)-2,6-bis(1,1′-dimethyle-thyl)benzene, 4,4′-(2-ethylhexylidene)-bis[1-(maleimidephenoxy)-benzene], 4,4′-(1-methylheptylidene)-bis[1-(maleimidephenoxy)-benzene], 4,4′-cyclohexylidene-bis[1-(maleimidephenoxy)-3-methylbenzene], and the like.

### Epoxy Resin

The epoxy resin can be selected from known epoxy resins. Examples thereof include a bisphenol A type epoxy resin, a bisphenol F type epoxy resin, a biphenyl type epoxy resin, a phenol novolak type epoxy resin, a cresol novolak type epoxy resin, a xylene novolak type epoxy resin, triglycidyl isocyanurate, an alicyclic epoxy resin, a dicyclopentadiene. novolak type epoxy resin, a biphenyl aralkyl novolak type epoxy resin, a phenol aralkyl novolak type epoxy resin, a naphthol aralkyl novolak type epoxy resin, a bisphenol A novolak type epoxy resin, a brominated bisphenol A type epoxy resin, a brominated phenol novolak type epoxy resin, a trifunctional phenol type epoxy resin, a tetrafunctional phenol type epoxy resin, a naphthalene type epoxy resin and a phosphorus-containing epoxy resin. Preferred examples thereof include a bisphenol A type epoxy resin, a bisphenol F type epoxy resin, a phenol novolak type epoxy resin, a cresol novolak type epoxy resin, a bisphenol A novolak type epoxy resin, a brominated bisphenol A type epoxy resin, a brominated phenol novolak type epoxy resin, a biphenyl type epoxy resin, a phenol aralkyl novolak type epoxy resin, a biphenyl aralkyl novolak type epoxy resin and a naphthol aralkyl novolak type epoxy resin. These epoxy resins may be used alone or in combination.

When the laminate or composite composition contains the epoxy resin a resin curing agent may be used. The above epoxy resin curing agent can be selected from generally known epoxy resin curing agents. Examples thereof include imidazole derivatives such as 2-methylimidazole, 2-ethyl-4-methylimidazole, 2-phenylimidazole, 1-cyanoethyl-2-phenylimidazole, 1-cyanoethyl-2-ethyl-4-methylimidazole, 2-phenyl-4,5-dihydroxymethylimidazole and 2-phenyl-4-methyl-5-hydroxymethylimidazole; amine compounds such as dicyandiamide, benzyldimethylamine and 4-methyl-N,N-dimethylbenzylamine; and phosphine compounds such as phosphonium compounds.

### Polyphenylene Oxide

Polyphenylene oxide (also called polyphenylene ether) may be used in the laminate or composite formulation. Exemplary polyphenylene oxides have the structure: [-Ph-O—]ₙ wherein Ph is an optionally substituted phenyl ring, and n falls in the range of about 10 up to about 200; with n in the range of about 10-100 is preferred.

### Styrene Maleic Anhydride

Styrene maleic anhydride, also known as SMA is a copolymer consisting of styrene and maleic anhydride monomers. The copolymer is typically formed by a radical polymerization, using an organic peroxide as the initiator resulting is an alternating monomer arrangement. It has a transparent appearance, high heat resistance, high dimensional stability, and the reactivity of the anhydride groups.

### Other Resins

Other resins that may be used in the laminate or composite formulation are rubbers like styrene-butadiene (SB), styrene-butadiene-styrene (SBS), a maleic anhydride grafted styrene-butadiene polymer (FG1901X and FG 1924 from Kraton Polymers), ethylene propylene diene monomer liquid rubbers, and vinyl-terminated polybutadiene rubber; polyimides, polyesters such as polyethylene terephthalate (PET), poly ether sulfones (PES), and fluoropolymers such as polytetrafluoroethylene (PTFE).

### Other Additives

The laminate or composite formulation may contain other additives known in the art such as an inorganic filler, a color pigment, an antifoamer, a surface conditioner, other flame retardants, an ultraviolet absorber, antioxidants and flow regulators, as required. Examples of the inorganic filler include silicas such as natural silica, fused silica, amorphous silica and hollow silica, white carbon, titanium white, aerosil, alumina, talc, natural mica, synthetic mica, kaolin, clay, calcined clay, calcined kaolin, calcined talc, mica; metal hydrates such as aluminum hydroxide, heat-treated aluminum hydroxide (obtained by heat-treating aluminum hydroxide and reducing part of crystal water), boehmite and magnesium hydroxide; molybdenum compounds such as molybdenum oxide and zinc molybdate, zinc borate, zinc stannate, barium sulfate, E-glass, A-glass, NE-glass, C-glass, L-glass, D-glass, S-glass, M-glass G20 and hollow glass. The average particle diameter of the inorganic filler is preferably 0.1 to 10 um. Inorganic fillers having different particle size distributions or different average particle diameters may be used in combination as required. The amount of the inorganic filler is not specially limited. The amount of the inorganic filler per 100 parts by weight of the resin components is preferably 10 to 300 parts by weight, particularly preferably 30 to 200 parts by weight.

### Base Substrate Material

The base substrate material used in the present invention can be selected from known base substrate materials which are used for various printed wiring board materials and composites. Examples thereof include inorganic fibers such as E glass, D glass, S glass, NE glass and quartz, and organic fibers such as polyimide, polyamide and polyester. The base material is properly selected according to intended use or performance as required. These base materials maybe used alone or in combination. The form of the base material is typically a woven fabric, a nonwoven fabric, roving, a chopped strand mat or a surfacing mat. The thickness of the base material is not specially limited. Generally, it is about 0.01 to 0.3 mm.

Further, base materials surface-treated with a silane-coupling agent or the like and physically-opening-treated woven fabrics can be preferably used in view of heat resistance after moisture absorption. Further, a film of polyimide, polyamide, polyester or the like may be also used. The thickness of the film is not specially limited and it is preferably about 0.002 to 0.05 mm A film surface-treated by plasma treatment or the like may be used.

The aforementioned flamed retardant may especially be used to form prepreg and/or laminates with epoxy compounds. Typical procedures for forming prepregs and laminates for printed wiring boards involve such operations as:
A) An epoxy-containing formulation such as one containing the aforementioned flame-retardant with an epoxy compound is formulated with solvents and curing or polymerization agents and optionally other conventional additives described above. The formulation is applied to or impregnated into a substrate by rolling, dipping, spraying, other known techniques and/or combinations thereof. The substrate is an inorganic or organic reinforcing agent in the form of fibers, fleece, fabric, or textile material, e.g., typically a woven or non-woven fiber mat containing, for instance, glass fibers or paper.
B) The impregnated substrate is “B-staged” by heating at a temperature sufficient to draw off solvent in the epoxy formulation and optionally to partially cure the epoxy formulation, so that the impregnated substrate cooled to room temperature is dry to the touch and can be handled easily. The “B-staging” step is usually carried out at a temperature of from 90° C. to 240° C. and for a time of from 1 minute to 15 minutes. The impregnated substrate that results from B-staging is called a “prepreg”. The temperature is most commonly 100° C. for composites and 130° C. to 200° C. for electrical laminates.
C) One or more sheets of prepreg are stacked or laid up in alternating layers with one or more sheets of a conductive material, such as copper foil, if an electrical laminate is desired.
D) The laid-up sheets are pressed at high temperature and pressure for a time sufficient to cure the resin and form a laminate. The temperature of this lamination step is usually between 100° C. and 240° C., and is most often between 165° C. and 200° C. The lamination step may also be carried out in two or more stages, such as a first stage between 100° C. and 150° C. and a second stage at between 165° C. and 200° C. The pressure is usually between 50 N/cm² and 500 N/cm². The lamination step is usually carried out for a time of from 1 minute to 200 minutes, and most often for 45 minutes to 120 minutes. The lamination step may optionally be carried out at higher temperatures for shorter times (such as in continuous lamination processes) or for longer times at lower temperatures (such as in low energy press processes).
E) Optionally, the resulting laminate, for example, a copper-clad laminate, may be post-treated by heating for a time at high temperature and ambient pressure. The temperature of post-treatment is usually between 120° C. and 250° C. The post-treatment usually is between 30 minutes and 12 hours.
F) Often an electrically-conductive printed circuit is applied to the copper-clad laminate.

Typically, the solvent for the epoxy resin in step A above is a ketone such as 2-butanone or methyl ethyl ketone (MEK). However, any other suitable type of conventionally-used solvent for forming these formulations can be employed. Examples of such other solvents include, but are not limited to acetone, methyl isobutyl ketone (MIBK), 2-methoxy ethanol, 1-methoxy-2-propanol, propylene glycol monomethyl ether, ethylene glycol monoethyl ether acetate, toluene, N,N-dimethylformamide, and mixtures thereof.

The curing or polymerization initializing agents that may be used for preparing the laminates are not limited to a specific curing or polymerization initializing agent as long as the agent helps polymerization of the epoxy resin in the flame-retardant epoxy composition. Examples of polymerization initializing agents are cationic polymerization initializing agents such as methane sulfonic acid, aluminum chloride, stannum chloride, trifluoroboron ethylamine complex, trifluoroboron ethylether complex and the like; radical polymerization initializing agents such as benzoyl peroxide, dicumyl peroxide, azo bis-isobutyronitrile and the like; and anionic polymerization initializing agents such as methoxy potassium, triethyl amine, 2-dimethyl aminophenol and the like and mixtures thereof.

The aforementioned epoxy curing agents include any agent known by a person skilled in the art. Examples, include but are not limited to: ethylene diamine, trimethylene diamine, tetramethylene diamine, hexamethylene diamine, meta phenylene diamine, para phenylene diamine, para xylene diamine, 4,4′-diamino diphenyl methane, 4,4′-diamino diphenyl propane, 4,4′-diamino diphenyl ether, 4,4′-diamino diphenyl sulfone, 4,4′-diamino dicyclohexane, bis(4-aminophenyl)phenyl methane, 1,5-diamino naphthalene, meta xylylene diamine, para xylylene diamine, 1,1-bis(4-aminophenyl)cyclohexane, dicyan diamide, phenol/formaldehyde novolac, cresol/formaldehyde novolac, bisphenol A novolac, biphenyl-, toluene-, xylene-, or mesitylene-modified phenol/formaldehyde novolac, aminotriazine novolac, cresol/formaldehyde/aminotriazine novolac, phenol/formaldehyde/aminotriazine novolac or mixtures thereof.

The amount of curing agent that may be used is based on the molar equivalence of curing functional groups in the curing agent to the molar equivalence of un-reacted epoxy groups in the phosphorus-containing epoxy resin. Thus, the curing agent amount may be from about 0.1 equivalence to about 10 equivalence or about 0.3 equivalence to about 5 equivalence, or about 0.7 equivalence to about 2 equivalence based on the equivalence of unreacted epoxy groups in the phosphorus-containing epoxy resin.

The polymerization initializing agents may be added in concentrations ranging from about 0.01 wt % to about 10 wt %, or about 0.05 to about 5%, or about 0.1 wt % to about 2 wt %, based on the total weight of the cured epoxy resin.

The curing temperature may be carried out generally between about 25° C. to about 250° C., or about 70° C. to about 240° C. or about 150° C. to about 220° C.

In addition, epoxy curing agent promoters may also be used to promote curing of the epoxy compositions. These epoxy curing agent promoters are often based on imidazoles. Examples of such epoxy curing agent promoters include, but are not limited to: 1-methylimidazole, 2-methylimidazole, 1,2-dimethylimidazole, 1,2,4,5-tetramethylimidazole, 2-ethyl-4-methylimidazole, 2-phenylimidazole, 1-cyanoethyl-2-phenylimidazole, 1-(4,6-diamino-s-triazinyl-2-ethyl)-2-phenylimidazole or mixtures thereof.

When phenol novolacs are used as curing agents, the epoxy curing agent promoter may be added in concentrations ranging from about 0.0001 wt % to about 5 wt %, or about 0.01 to about 3%, or about 0.1 wt % to about 2 wt %, or about 0.15 wt % to about 1 wt %, based on the weight of curing agent used. Higher concentrations of promoter may be used with different curing agents, such as DICY, dicyandiamide, where promoter concentrations are more typically in the 5-25 wt % range, based on weight of curing agent.

The curing temperature may be carried out generally between about 25° C. to about 250° C., or about 70° C. to about 240° C. or about 150° C. to about 220° C.

### Amounts

The amount of Flame retardant of Formula I used in the laminate or composite formulation is typically about 1% to about 30 wt %, or about 3% to about 25 wt %, or about 5% to about 20 wt %, based on the total weight of the resins in the composite or laminate formulation.

The cyanate ester resin may be used alone or is typically combined with an epoxy or a bismaleimide monomer. When the cyanate ester resin is combined with the epoxy, the amount of the epoxy resin is preferably about 10 to about 90% by weight, particularly preferably about 30% to 70% by weight, based on the total amount of the cyanate ester compound and the epoxy resin. When the bismaleimide is used, the amount of the maleimide compound is preferably about 5% to about 75% by weight, particularly preferably about 10 to about 70% by weight, based on the total amount of the cyanate ester resin and the maleimide compound. The polybenzoxazines may be used alone or in combination with the other components typically within the same amounts used for the cyanate esters.

Other thermoset embodiments of the present invention are shown below.

The present invention also relates to a thermoset composition comprising: (a) 0-50 parts by weight of at least one cyanate ester, (b) 0-50 parts by weight of at benzoxazine monomer; (c) 0-50 parts by weight of at least one bismaleimide, (d) 10-100 parts by weight of at least one epoxy compound; and (e) 5-60 parts by weight of the phosphorus compound having the formula I. Another embodiment is where wherein R² and R³ in Formula I are independently hydrogen or a C₁-C₆ alkyl. A further embodiment is where wherein R² and R³ in Formula I are hydrogen and all R⁴ substituents in Formula I are hydrogen. Another embodiment is a composition comprises (a) 10-50 parts by weight of at least one cyanate ester, (b) 10-50 parts by weight of at benzoxazine monomer; (c) 10-50 parts by weight of at least one bismaleimide, (d) 10-100 parts by weight of at least one epoxy compound; and (e) 5-60 parts by weight of the phosphorus compound having formula I.

The present invention also relates to a thermoset composition comprising: (a) 30-100 parts by weight of at least styrene-butadiene (SB) rubber, (b) 0-50 parts by weight of a styrene-butadiene-styrene (SBS) rubber; (c) 0-50 parts by weight of at least one bismaleimide, (d) 0-50 parts by weight of a maleic anhydride grafted styrene-butadiene polymer; (e) 0-50 parts of an ethylene propylene diene monomer liquid rubber, (f) 0-50 pans of a vinyl-terminated polybutadiene rubber and (g) 0-50 parts of a polyphenylene oxide resin and (h) 5-60 parts of the phosphorus compound of Formula I. Another embodiment is where wherein R² and R³ in Formula I are independently hydrogen or a C₁-C₆ alkyl. A further embodiment is where wherein R² and R³ in Formula I are hydrogen and all R⁴ substituents in Formula I are hydrogen. Another embodiment is a composition comprises (a) 10-50 parts by weight of at least one cyanate ester, (b) 10-50 parts by weight of at benzoxazine monomer; (c) 10-50 parts by weight of at least one bismaleimide, (d) 10-100 parts by weight of at least one epoxy compound; and (e) 5-60 parts by weight of the phosphorus compound having formula I.

### Experimental Procedure

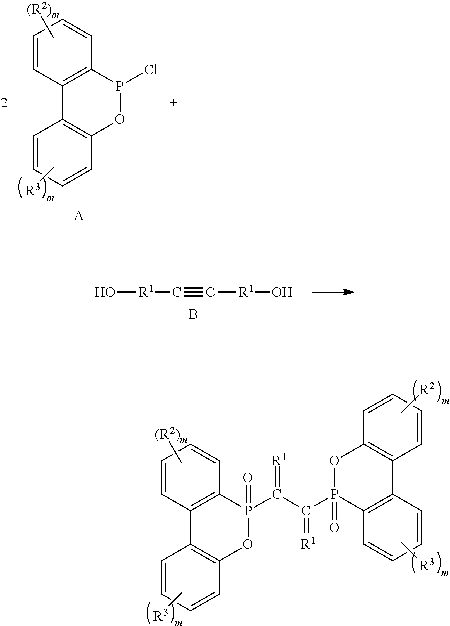

The compounds of the present invention may be produced by reacting approximately 2 equivalents of the chloro-dopo compound of Formula A with approximately one equivalent of the butyne diol compound of Formula B, optionally in presence of a base to neutralize the HCl produced and an optional solvent, to form the compound of the present invention, wherein R¹, R² and R³ are defined above. The reaction temperature may be from about 20° C. to about 100° C.

Any suitable optional base may be used to neutralize the HCl produced in the reaction including organic or inorganic bases.

Also, any optional suitable solvent may be used in the reaction. Examples of such suitable solvent may include: include, but are not limited to heptane, hexane, chloroform, chlorobenzene, petroleum ether, methylcyclohexane; dichloromethane, toluene, xylenes, ethyl benzene, tetrahydrofuran, DMSO, 1,4-dioxane, acetonitrile, ethylene glycol dimethyl ether, ethylene glycol diethyl ether or mixtures thereof.

The following Examples illustrate the present invention. It is to be understood, however, that the invention, as fully described herein and as recited in the claims, is not intended to be limited by the details of the following Examples.

### Example 1

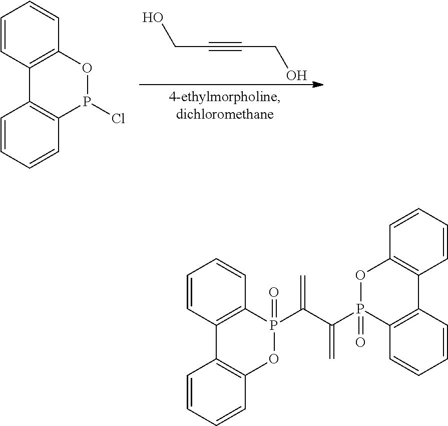 [SMILES: ClP1Oc2ccccc2-c2ccccc21 ; OCC#CCO ; C=C(C(=C)P1(=O)Oc2ccccc2-c2ccccc21)P1(=O)Oc2ccccc2-c2ccccc21]

TABLE 1
Reaction Starting Material Components

| | MW | m.p. | b.p. | Physical | density | | | |
|---|---|---|---|---|---|---|---|---|
| Component | (g/mol) | (° C.) | (° C.) | state | (g/mL) | moles | grams | Eq. |
| DOPO-Cl | 234.62 | 60-70 | 170 at | Solid | — | 2.266 | 531.63 | 2.01 |
| CAS# 22749-43-5, | | | 2 mmHg | | | | | |
| prepared similar to | | | | | | | | |
| U.S. Pat. No. 3,702,878 | | | | | | | | |
| 2-Butyne-1,4-diol | 86.09 | 53 | 238 | Solid | — | 1.130 | 97.26 | 1.00 |
| CAS# 110-65-6 | | | | | | | | |
| Sigma-Aldrich, St. | | | | | | | | |
| Louis, MO | | | | | | | | |
| 4-Ethyl | 115.18 | −62.8 | 138 | Liquid | 0.91 | 2.370 | 273 | 2.10 |
| morpholine | | | | | | | | |
| CAS# 100-74-3, | | | | | | | | |
| Sigma-Aldrich, St. | | | | | | | | |
| Louis, MO | | | | | | | | |
| Dichloromethane | 84.93 | −97 | 40 | Liquid | 1.33 | — | 1837 | — |
| CAS# 75-09-2, | | | | | | | | |
| Sigma-Aldrich, St. | | | | | | | | |
| Louis, MO | | | | | | | | |

A 4000-mL, 5-neck reaction vessel with circulating oil jacket was equipped with a mechanical stirrer, a condenser, a thermocouple, and a 1000-ml addition funnel. The addition funnel was equipped with a short section of Teflon tubing for smooth delivery to the reactor and a glass plug at the top. A nitrogen line with a bubbler was fitted to the top of the condenser.

DOPO-Cl, (531.63 g, 2.266 mol) was dissolved in dichloromethane (1645 g) and transferred to the reactor. A solution of 2-butyne-1,4-diol (97.26 g, 1.129 mol), 4-ethylmorpholine (273.0 g, 2.370 mol), and dichloromethane (192 g) was transferred to the addition funnel.

The oil jacket of the reaction vessel was cooled to −15° C. The condenser was cooled to 10° C. Once the thermocouple indicated that the interior temperature of the reaction vessel was 0° C., the solution was slowly added to the reaction vessel to maintain a temperature of less than 15° C. After addition, the mixture was allowed to come to room temperature.

1.5 L of water and 0.5 L of chloroform were added to the reactor. Phases were mixed and allowed to separate, and then 1 L of the lower organic layer was drained. Another 0.5 L of chloroform was added to dissolve more of the product and the phases mixed, allowed to separate, and 1.2 L of the organic layer drained. A final 0.5 L of chloroform is added, the phases mixed and allowed to separate, and 0.8 L of organic layer drained. The remaining aqueous phase was extracted with 0.2 L of chloroform, and then discarded. The reactor was cleaned and allowed to dry.

All organic phases were combined and returned to the reactor. Approximately 0.5 L of brine was added to the reactor and the phases mixed and allowed to separate. The organic layer was drained and then dried over 25 g sodium sulfate. The sodium sulfate was then filtered out of the mixture to give a clarified solution.

After cleaning the reactor once again, the solution was returned to the reactor and the solvent distilled. 1.5 L of toluene was added and 1 L distilled to drive off traces of chloroform and dichloromethane. 2 L of ethylacetate was added and the thick, heavy mixture refluxed with rapid mixing for 1 hr. The mixture was brought to room temperature over 2 hrs, and then drained and filtered. The mother liquor was used to rinse residual solid product from the reactor, then the accumulated product was washed with 0.5 L of ethylacetate.

After air-drying for 16 hours, the off-white solid was ground to a powder with a KitchenAid blade coffee grinder and the powder dried in a vacuum oven for 8 hours to give 469 g of product (86.0% yield). The off-white to yellowish powder, which was an unresolved mixture of diastereomers, had the following characteristics: ¹H-NMR (400 MHz, CDCl₃): δ 7.85 (4H, m), 7.60 (4H, m), 7.33 (4H, m), 7.23 (2H, t, J=7.6 Hz), 7.06 (2H, dd, J=13.6, 8.0 Hz), 6.40 (2H, dd, J=42.4, 5.2 Hz), 6.30 ppm (2H, dd, J=20.4, 28.2 Hz) ppm ³¹P-NMR(162 MHz, CDCl₃, ¹H decoupled): δ 23.2 (s, 1P), 22.9 (s, 1P) ppm, 160-165° C. melting point.

### Example 2

In general, stock solutions of advanced resin, curative and promoter are all prepared and stored separately to facilitate experimentation. An 85 wt % phenol epoxy novolac resin solution, DEN® 438-EK85, containing 15 wt % 2-butanone (MEK) was obtained from The Dow Chemical Company. Durite SD-1702 novolac curing agent was obtained from Hexion Corporation. A novolac resin solution was prepared by dissolving 50 wt % SD-1702 in 50 wt % MEK solvent.

The flame-retardant compound made in Example 1 containing 12.8 wt % P was coffee bean ground to an average particle size of 13.3 micron (d₅₀=6.3 micron). A flame-retardant resin mixture containing 3.0 wt % P was prepared by adding 126.3 g of 85 wt % DEN 438 solution, 126.0 g of 50 wt % SD-1702 solution, 52.0 g flame-retardant compound and 0.161 g 2-phenylimidazole promoter. The novolac to promoter ratio was about 392. An additional 80 g MEK was added to the resin solution. The flame-retardant completely dissolved in the solution with heating at about 40° C. About 0.5-1 mL of the resin solution was added to a hot cure plate (Thermo-electric company) at about 162-164° C. A tongue depressor was split in half lengthwise, and half of the depressor was used to move the resin on the hot plate until stiffness was noted and then lifting the resin with the flat part of the depressor until string formation ceased. The gel time was 3 minutes, 58 seconds, determined by the point where resin “strings” could no longer be pulled from the resin mixture and the epoxy becomes “tack free.”

An 11 inch by 11 inch square woven glass fabric (7628 glass with 643 finish from BGF Industries) was cut to size from a large roll and stapled to wood supports (12 inches long, 1 inch wide and 1/16 inch thick) on the top and bottom ends of the fabric. The wood supports contained holes in the corners for inserting paper clips on one end for hanging the fabric in the B-stage oven. The A-stage, or resin varnish, was painted on the front and back of the fabric. Paper clips were unfolded and inserted into the both holes of one wood support. The resin-saturated fabric was hung from aluminum supports in a laboratory fume hood and allowed to drip dry for about one minute before hanging in a pre-heated (to 170° C.) forced air Blue M oven (Lab Safety Supply Inc., a unit of General Signal) for 3 minutes. The edges of the B-staged prepreg were removed by reducing the sheet dimensions to 10 inch by 10 inch. The sheet was cut into four 5 inch by 5 inch sheets and weighed before stacking the four layers of prepreg between two layers of Pacothane release film (Insulectro Corp.) and two steel plates (⅛ inch thick, 12 inch by 12 inch square dimensions). The laminate was formed in the hot press at 5,000 psig for 1 hour. The resulting laminate was 0.032 inches thick, contained 42 wt % resin and underwent 7 wt % resin overflow during pressing. Five 0.5 inch wide coupons were cut from the laminate using a diamond saw, and the coupon edges were smoothed with sandpaper. The flammability of the coupons were screened by ASTM D3801-06 using an Atlas UL-94 burn chamber, resulting in a V-0 rating with 48 seconds total burn time for the two ignitions on all five coupons.

### Examples 3-11

The procedure used in Example 2 was used to develop prophetic laminate formulas for Examples 3-11 in Table 2 (wt % basis) with the exception that a higher functional o-cresol Novolac type epoxy resin (Nan Ya NPCN-703) is used in place of the phenol epoxy novolac resin and in some examples silica and/or melamine polyphosphate (Melapur 200 (M-200) from BASF Corporation) are used in the resin mixtures. PFR is the phosphorus flame retardant produced in Example 1

TABLE 2
Formulation Examples 3-11

| | | | | | | | | Ex | Ex |
|---|---|---|---|---|---|---|---|---|---|
| Ingredient | Ex 3 | Ex 4 | Ex 5 | Ex 6 | Ex 7 | Ex 8 | Ex 9 | 10 | 11 |
| PFR | 23.4 | 16.4 | 11.9 | 10.6 | 7.4 | 10 | 7 | 9 | 8.4 |
| M-200 | | | 11.2 | 10 | 7 | 9.5 | 6.5 | 8.5 | 8 |
| silica | | 30 | | | 30 | | 30 | | |
| Total wt % P | 3.0 | 2.1 | 3.0 | 2.7 | 1.9 | 2.5 | 1.8 | 2.3 | 2.1 |

### Examples 12-17

The following prophetic Examples 12-17 are presented for the purposes of illustration and are not to be taken as limitations on the scope of the invention. In these Examples, the compositions are processed according to the following procedure. First, the resins, flame retardants, fillers, and all other components in Table 14 below (parts per weight) are thoroughly mixed to form a slurry in conventional mixing equipment. The mixing temperature is regulated to avoid substantial decomposition of the curing agent (and thus premature cure). Next, conventional prepreg manufacturing methods are employed.

Typically, the web would be impregnated with the slurry, metered to the correct thickness, and then solvent would be removed (evaporated to form a prepreg). The lamination process entails a stack-up of 6 prepreg layers between two sheets of copper foils (Oak Mitsui TOC 500 LZ or Circuit Foil TWS) uncoated or previously coated with the adhesive layer. This stack-up would then be densified and cured via flat bed lamination; typical cure temperature ranges were between about 325° F. (163° C.) and about 475° F. (246° C.) and pressure between 300-1200 psi.

In table 3 below, PER is the phosphorus flame retardant produced in Example 1, Kraton® D-1118 a sytyrene-butadiene (SB) diblock copolymer (20%) and styrene-butadiene-styrene (SBS) triblocrk copolymer (80%) from baton Polymers. Trilene 65 is an ethylene propylene diene monomer liquid lubber from Crompton Corp., B-3000 is a vinyl-terminated polybutadiene from Nippon Soda, Varox® DCP is a dicumyl peroxide curing agent from RT Vanderbilt, Melapur 200 is a melamine polyphosphate from BASF Corp. MGZ-6R is a silica coated magnesium hydroxide from Sakai Chemicals. Naugard® XL is an antioxidant (1,2-dioxoethane-1,2-diyl)bis(iminoethane-2,1-diyl)bis[3-(3,5-di-tert-butyl-4-hydroxyphenyl)propanoate], from Addivant Corporation. A74NT is a aminosilane from Gelest, Inc.

TABLE 3
Formulation Examples 12-17

| Ingredient | Ex 12 | Ex 13 | Ex 14 | Ex 15 | Ex 16 | Ex 17 |
|---|---|---|---|---|---|---|
| Kraton D-1118 | 25 | 25 | 25 | 25 | 25 | 25 |
| Trilene 65 | 10 | 10 | 10 | 10 | 10 | 10 |
| B-3000 | 80 | 80 | 80 | 80 | 80 | 80 |
| A74NT | 0.5 | 0.5 | 1 | 1.5 | 2.0 | 2.0 |
| Naugard XL | 0.5 | 0.5 | 0.5 | 0.5 | 0.5 | 0.5 |
| Varox DCP | 2.2 | 2.2 | 2.2 | 2.2 | 2.2 | 2.2 |
| MGZ-6R | | | 50 | 100 | 200 | 300 |
| PFR | 120 | 60 | 45 | 30 | 20 | 10 |
| Melapur 200 | | 60 | 45 | 30 | 20 | 10 |

The results would show that the laminate composition would have excellent flame retardant, mechanical and electrical properties.

### Examples 18-24

The following prophetic Examples 18-24 are presented for the purposes of illustration and are not to be taken as limitations on the scope of the invention. In these Examples, the laminates are processed similar to the procedure in Examples 3-5. All amounts are parts per weight.

In Table 4 below, PFR is the phosphorus flame retardant produced in Example 1, AroCy® L-10 and XU378 are Cyanate Esters based on bisphenol F and Bisphenol-M from Huntsman Corp, BM-200 is 4,4-diphenyimethane bismaleimide from Otsuka Chemical. Araldite® LZ8282 is a benzoxazine resin based on bisphenol F from Huntsman Corp. NPCN-703 is 60 wt % an o-cresol Novolac type epoxy resin from Nan Ya Plastics Corp. NC-3000H is a biphenyl aralkyl novolak type epoxy resin from Nippon Kayaku Co. YPX™ 100F is a polyphenylene ether from Mitsubishi Gas Chemical Co. Delacal™ NFR HP is a nitrogen synergists comprising constituents of Melem and Melam from Delamin Limited. MGZ-6R is a silica coated magnesium hydroxide from Sakai Chemicals. SMA® 1000 is a styrene-maleic anhydride copolymer with styrene/maleic anhydride molar ratios of 1:1 from Cray Valley USA.

TABLE 4
Formulation Examples 18-24

| Ingredient | Ex 18 | Ex 19 | Ex 20 | Ex 21 | Ex 22 | Ex 23 | Ex 24 |
|---|---|---|---|---|---|---|---|
| AroCy ® L-10 | 50 | 50 | 50 | 50 | 50 | 50 | 50 |
| AroCy ® XU 378 | 50 | 50 | 50 | 50 | 50 | 50 | 50 |
| BM-200 | | | 30 | 30 | 30 | 30 | 30 |
| PFR | 30 | 15 | 15 | 10 | 15 | 15 | 10 |
| Araldite ® LZ8282 | | | | 30 | 30 | 30 | 30 |
| NPCN-703 | | 15 | | 15 | 15 | 15 | 15 |
| NC-3000H | | 15 | | 15 | 15 | 15 | 15 |
| YPX ™ 100F | | | | | 15 | 50 | 15 |
| SMA ® 1000 | | | | | | | 10 |
| Silica Filler | | | | 50 | | 100 | 50 |
| MGZ-6R | | | | 25 | | | 25 |
| Zinc Octylate | 0.1 | | 0.1 | 0.1 | 0.1 | 0.1 | 0.1 |
| 2-phenylimidazole | | 0.1 | 0.1 | 0.1 | 0.1 | 0.1 | 0.1 |
| Delacal ™ NFR HP | | | | 10 | | | 10 |

The results would show that the laminate composition would have excellent flame retardant, mechanical and electrical properties.

### Examples 25-31

The following prophetic Examples 25-31 are presented for the purposes of illustration and are not to be taken as limitations on the scope of the invention. In these Examples, the laminates are processed similar to the procedure in Examples 38-40. All amounts are parts per weight.

Kraton® D-1118 a styrene-butadiene (SB) diblock copolymer (20%) and styrene-butadiene-styrene (SBS) triblock copolymer (SC %) from Kraton Polymers. BM-200 is 4,4-diphenylmethane bismaleimide from Otsuka Chemical, YPX™ 100F is a polyphenylene ether from Mitsubishi Gas Chemical Co. Ricon® 156MA17 from Sartomer (subsidiary of the Arkema group) is a polybutadiene resin with maleic anhydride additions. Kraton® FG1901X is a maleic anhydride grafted polybutadiene-styrene copolymer from Kraton Polymers. MGZ-6R is a silica coated magnesium hydroxide from Sakai Chemicals. SMA® 1000 is a styrene-maleic anhydride copolymer with styrene/maleic anhydride molar ratios of 1:1 from Cray Valley USA.

TABLE 5
Formulation Examples 25-31

| Ingredient | Ex 25 | Ex 26 | Ex 27 | Ex 28 | Ex 29 | Ex 30 | Ex 31 |
|---|---|---|---|---|---|---|---|
| Kraton ® D-118 | 50 | 50 | 50 | 50 | 50 | 50 | 50 |
| BM-200 | 50 | | | 30 | 30 | 30 | 30 |
| PFR | 15 | 15 | 15 | 10 | 15 | 15 | 10 |
| Ricon 156MA17 | | | 15 | 30 | | 30 | 30 |
| Kraton ® FG1901X | | 25 | 15 | 15 | | 15 | 15 |
| YPX ™ 100F | | | | | 50 | 50 | 30 |
| SMA ® 1000 | | | | | | | 10 |
| Silica Filler | 25 | 25 | 50 | 50 | | 100 | 50 |
| MGZ-6R | | | | 50 | | | 50 |
| Delacal ™ NFR HP | 5 | | | 10 | | | 10 |
| Dicumyl peroxide | 5 | 5 | 5 | 5 | 5 | 5 | 5 |

The results would show that the laminate composition would have excellent flame retardant, mechanical and electrical properties.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention described and claimed herein is not to be limited in scope by the specific examples and embodiments herein disclosed, since these examples and embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A compound having the following structure: 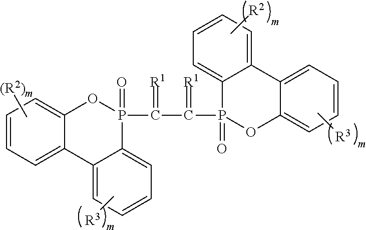
wherein R¹ is C(R⁴)₂;
each R² and R³ are independently hydrogen, C₁-C₁₅ alkyl, C₆-C₁₂ aryl, C₇-C₁₅ aralkyl or C₇-C₁₅ alkaryl; or R² and R³ taken together can form a saturated or unsaturated cyclic ring, wherein said saturated or unsaturated cyclic ring may be optional substituted by a C₁-C₆ alkyl;
each R⁴ is independently hydrogen, C₁-C₆ alkyl, C₆-C₁₂ aryl or C₃-C₁₂ cycloalkyl;
and each m is independently 1, 2, 3 or 4.

2. The compound of claim 1, wherein R² and R³ are independently hydrogen or a C₁-C₆ alkyl.

3. The compound of claim 2, wherein all R⁴ substituents are hydrogen.

4. The compound of claim 3, wherein R² and R³ are hydrogen.

5. A flame-retardant polymer composition comprising a polymer and the compound of claim 1.

6. The composition of claim 5, wherein said polymer is polyolefins, polyesters, polyethers, polyketones, polyamides, natural and synthetic rubbers, polyurethanes, polystyrenes, poly(meth)acrylates, phenolic resins, polyacetals, polyacrylonitriles, polybutadienes, polystyrenes, polyimides, polyamideimides, polyetherimides, polyphenylsulfides, polyphenylene oxide, polycarbonates, polyketones, cellulose, cellulose derivatives, epoxy resins or mixtures thereof.

7. (canceled)

8. The composition of claim 6, wherein said polymer is a phenolic resin or an epoxy resin, and wherein said composition further contains a curing or polymer initiation agent.

9. A prepreg or laminate comprising an organic or inorganic reinforcing material and the composition of claim 8.

10. The composition of claim 6, wherein the amount of the compound is about 0.1 to about 100 parts by weight per 100 parts by weight of polymer.

11. (canceled)

12. (canceled)

13. A thermoset composition comprising: (a) 0-50 parts by weight of at least one cyanate ester, (b) 0-50 parts by weight of at benzoxazine monomer; (c) 0-50 parts by weight of at least one bismaleimide, (d) 10-100 parts by weight of at least one epoxy compound; and (e) 5-60 parts by weight of the phosphorus compound having the formula: 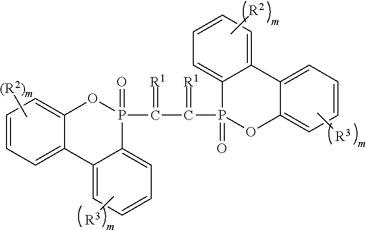
wherein R¹ is C(R⁴)₂;
each R² and R³ are independently hydrogen, C₁-C₁₅ alkyl, C₆-C₁₂ aryl, C₇-C₁₅ aralkyl or C₇-C₁₅ alkaryl; or R² and R³ taken together can form a saturated or unsaturated cyclic ring, wherein said saturated or unsaturated cyclic ring may be optional substituted by a C₁-C₆ alkyl;
each R⁴ is independently hydrogen, C₁-C₆ alkyl, C₆-C₁₂ aryl or C₃-C₁₂ cycloalkyl;
and each m is independently 1, 2, 3 or 4.

14. The compound of claim 13, wherein R² and R³ are independently hydrogen or a C₁-C₆ alkyl.

15. The compound of claim 13, wherein all R⁴ substituents are hydrogen and wherein R² and R³ are hydrogen.

16. The composition of claim 15 wherein the composition comprises (a) 10-50 parts by weight of at least one cyanate ester, (b) 10-50 parts by weight of at benzoxazine monomer; (c) 10-50 parts by weight of at least one bismaleimide, (d) 10-100 parts by weight of at least one epoxy compound; and (e) 5-60 parts by weight of the phosphorus compound having formula I.

17. A thermoset composition comprising: (a) 30-100 parts by weight of at least styrene-butadiene (SB) rubber, (b) 0-50 parts by weight of a styrene-butadiene-styrene (SBS) rubber; (c) 0-50 parts by weight of at least one bismaleimide, (d) 0-50 parts by weight of a maleic anhydride grafted styrene-butadiene polymer; (e) 0-50 parts of an ethylene propylene diene monomer liquid rubber, (f) 0-50 parts of a vinyl-terminated polybutadiene rubber and (g) 0-50 parts of a polyphonylene oxide resin and (h) 5-60 parts of the phosphorus compound 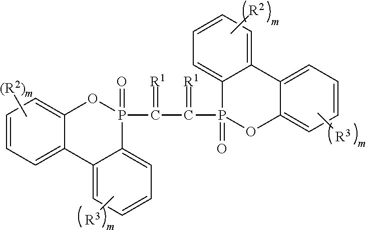
wherein R¹ is C(R⁴)₂;
each R² and R³ are independently hydrogen, C₁-C₁₅ alkyl, C₆-C₁₂ aryl, C₇-C₁₅ aralkyl or C₇-C₁₅ alkaryl; or R² and R³ taken together can form a saturated or unsaturated cyclic ring, wherein said saturated or unsaturated cyclic ring may be optional substituted by a C₁-C₆ alkyl;
each R⁴ is independently hydrogen, C₁-C₆ alkyl, C₆-C₁₂ aryl or C₃-C₁₂ cycloalkyl;
and each m is independently 1, 2, 3 or 4.

18. The compound of claim 17, wherein R² and R³ are independently hydrogen or a C₁-C₆ alkyl.

19. The compound of claim 17, wherein all R⁴ substituents are hydrogen and wherein R² and R³ are hydrogen.

20. The composition of claim 19 wherein the composition comprises (a) 10-50 parts by weight of at least one cyanate ester, (b) 10-50 parts by weight of at benzoxazine monomer; (c) 10-50 parts by weight of at least one bismaleimide, (d) 10-100 parts by weight of at least one epoxy compound; and (e) 5-60 parts by weight of the phosphorus compound having formula I.

21. A process for preparing the compound of Formula I: 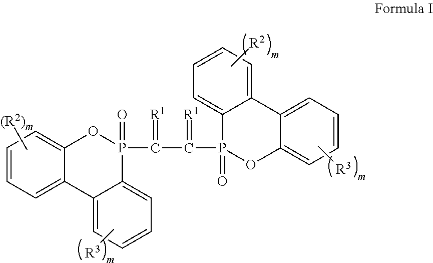
wherein R¹ is C(R⁴)₂;
each R² and R³ are independently hydrogen, C₁-C₁₅ alkyl, C₆-C₁₂ aryl, C₇-C₁₅ aralkyl or C₇-C₁₅ alkaryl; or R² and R³ taken together can form a saturated or unsaturated cyclic ring, wherein said saturated or unsaturated cyclic ring may be optional substituted by a C₁-C₆ alkyl;
each R⁴ is independently hydrogen, C₁-C₆ alkyl, C₆-C₁₂ aryl or C₃-C₁₂ cycloalkyl;
and each m is independently 1, 2, 3 or 4.
comprising reacting a compound of Formula A 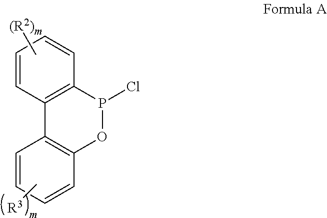
with a compound of Formula B: 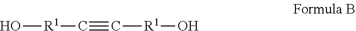
in the presence of an optional base and an optional solvent wherein m, and R¹ to R³ are defined above.
